(19) United States
(12) Patent Application Publication
(10) Pub. No.: US 2024/0040625 A1
(43) Pub. Date: Feb. 1, 2024

(54) TIMING ADVANCES FOR RANDOM ACCESS

(71) Applicant: QUALCOMM Incorporated, San Diego, CA (US)

(72) Inventors: Lianghai JI, San Diego, CA (US); Jun MA, San Diego, CA (US); Huilin XU, Temecula, CA (US); Qiang WU, San Diego, CA (US); Mohamad SAYED HASSAN, Paris (FR); Liangping MA, San Diego, CA (US); Mehmet Izzet GURELLI, San Diego, CA (US); Weimin DUAN, San Diego, CA (US); Karthik ANANTHA SWAMY, La Jolla, CA (US)

(21) Appl. No.: 17/816,485

(22) Filed: Aug. 1, 2022

(51) Int. Cl. H04W 74/08

(52) U.S. Cl. CPC H04W 74/0833

(57) ABSTRACT

Certain aspects of the present disclosure provide techniques for random access. A method for wireless communications by a user equipment (UE) includes determining a first timing advance (TA) for transmitting a random access channel (RACH) preamble. The method includes determining a second TA, different than the first TA, for transmitting the RACH preamble. The method includes transmitting the RACH preamble using the second TA. The method includes receiving a random access response (RAR) message including a timing advance command (TAC) and determining whether the RAR is intended for the UE based on the TAC, the first TA, and the second TA. The method includes transmitting a physical uplink shared channel (PUSCH) transmission based on a determination that the RAR is intended for the UE.

### BACKGROUND

### Field of the Disclosure

Aspects of the present disclosure relate to wireless communications, and more particularly, to techniques for random access.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In random access, UEs transmit a random access preamble as part of a random access procedure. Because there are a limited number of random access preambles and random access channel (RACH) resources, UEs may transmit random access preambles that collide. That is, the UEs may transmit identical random access preambles using the same RACH resources. When UEs transmit colliding random access preambles, the network transmission random access response message with a timing advance command, and both (or however many UEs transmit the colliding random access preambles) UEs receive the random access response message and transmit a physical uplink shared channel (PUSCH) payload to the network using the same TAC. Thus, the PUSCH transmissions from the UEs also collide at the network entity. The network entity may not be able to successfully decode one or more of the colliding PUSCH transmissions. In this case, the UEs may need to retransmit the PUSCH transmission and/or the random access preamble, thereby limiting the channel capacity.

According to aspects of the present disclosure, UEs may be configured to independently determine a second timing advance based on a first timing advance and transmit random access preamble using the second timing advance. When the network entity transmits a random access response message with a TAC, each UE can determine whether the random access response message is intended for itself based, for example, on the TAC, the first timing advance, and the second timing advance. For example, the UE may determine whether the random access response message is intended for itself based on a difference between the TAC and the difference between the first and second timing advances. The UE can then determine whether to send a PUSCH transmission to the network entity based on whether the random access response message was determined to be intended for that UE or not. Accordingly, PUSCH transmission collisions at the network entity can be avoided, thereby increasing the channel capacity.

One aspect provides a method for wireless communication by a user equipment (UE). The method includes determining a first timing advance (TA) for transmitting a random access channel (RACH) preamble. The method includes determining a second TA, different than the first TA, for transmitting the RACH preamble. The method includes transmitting the RACH preamble using the second TA. The method includes receiving a random access response (RAR) message including a timing advance command (TAC). The method includes determining whether the RAR is intended for the UE based on the TAC, the first TA, and the second TA. The method includes transmitting a physical uplink shared channel (PUSCH) transmission based on a determination that the RAR is intended for the UE.

Another aspect provides a method for wireless communication by a network entity. The method includes outputting a TA configuration for a first UE and a second UE. The method includes obtaining a first RACH preamble from the first UE using a first TA and a second RACH preamble from the second UE using a second TA. The first RACH preamble and the second RACH preamble comprise an identical RACH sequence. The method includes outputting a RAR message including a TAC. The method includes obtaining a PUSCH transmission from the UE or the second UE based on the TAC.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example four-step RACH procedure.

FIG. 6 depicts an example two-step RACH procedure.

FIG. 7 depicts an example MSG2 collision and MSG3 collision in a four-step RACH procedure.

FIG. 8 depicts an example non-terrestrial network (NTN).

FIG. 9 depicts an example process flow for timing advances in a four-step RACH procedure in a network between a network entity, a first UE, and a second UE.

FIG. 10 depicts another example process flow for timing advances in a four-step RACH procedure in a network between a network entity, a first UE, and a second UE.

FIG. 11 depicts an example process flow for timing advances in a two-step RACH procedure in a network between a network entity, a first UE, and a second UE.

FIG. 12 depicts an example method for wireless communications by a UE.

FIG. 13 depicts an example method for wireless communications by a network entity.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for timing advances in random access.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

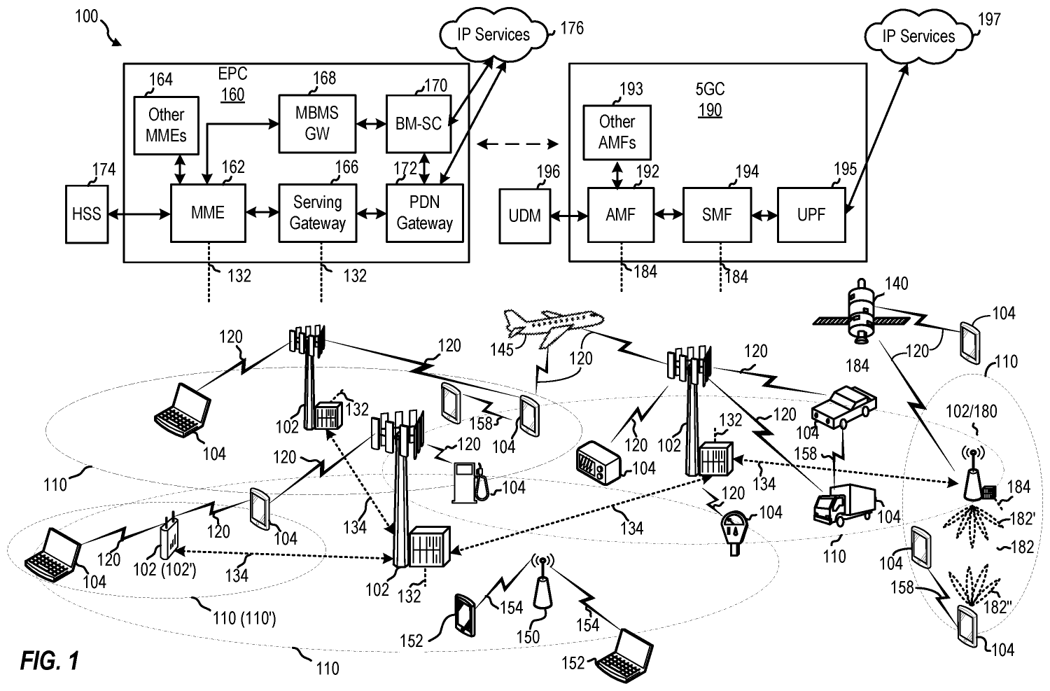

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

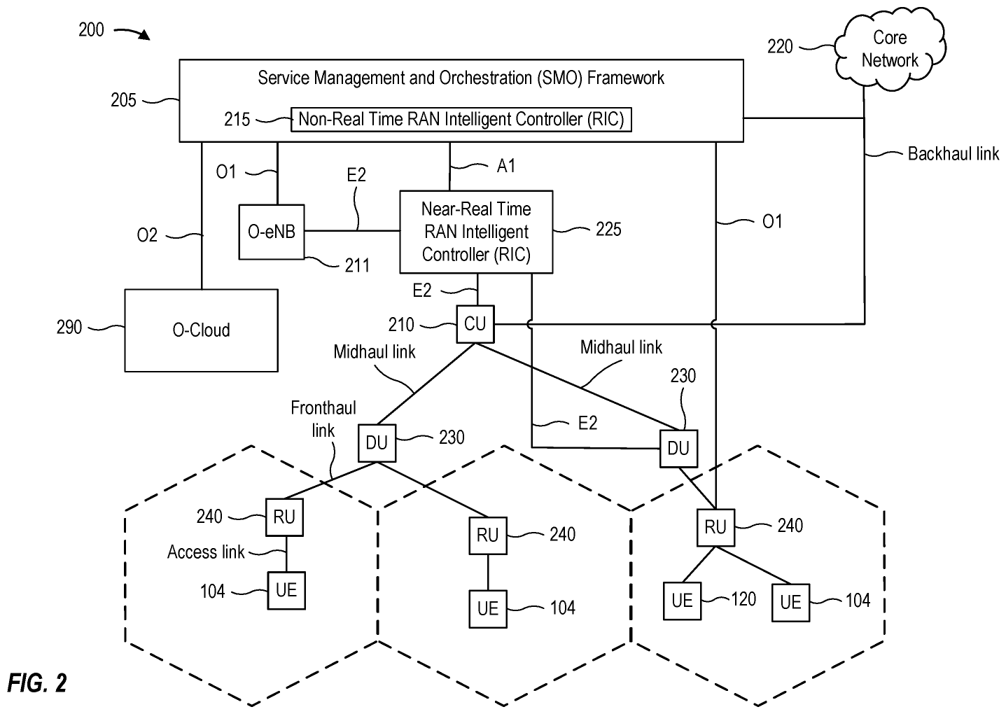

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5GNR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

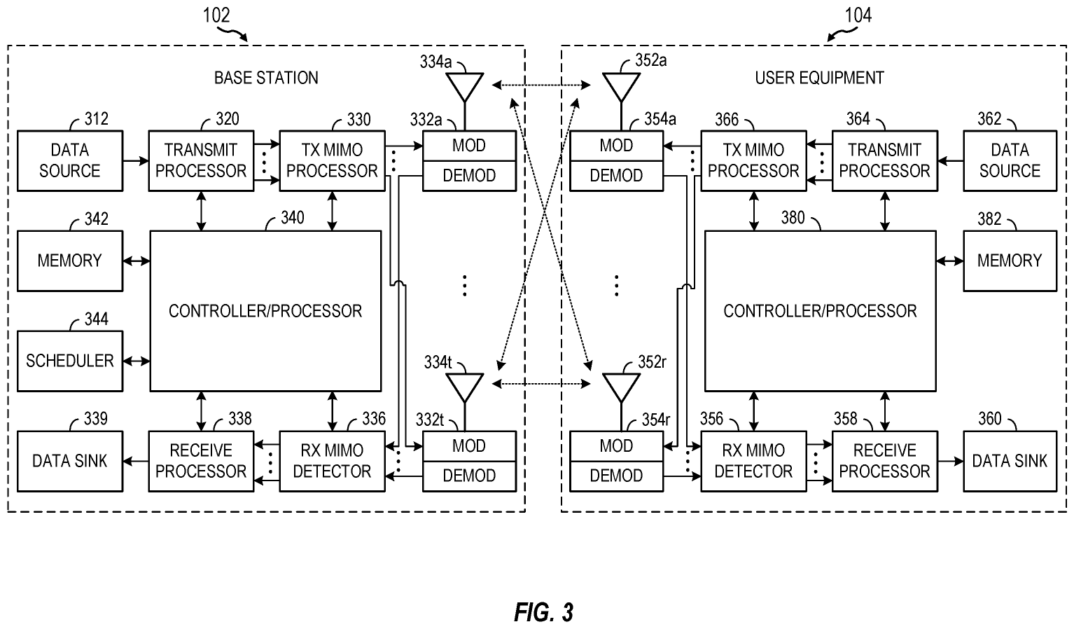

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

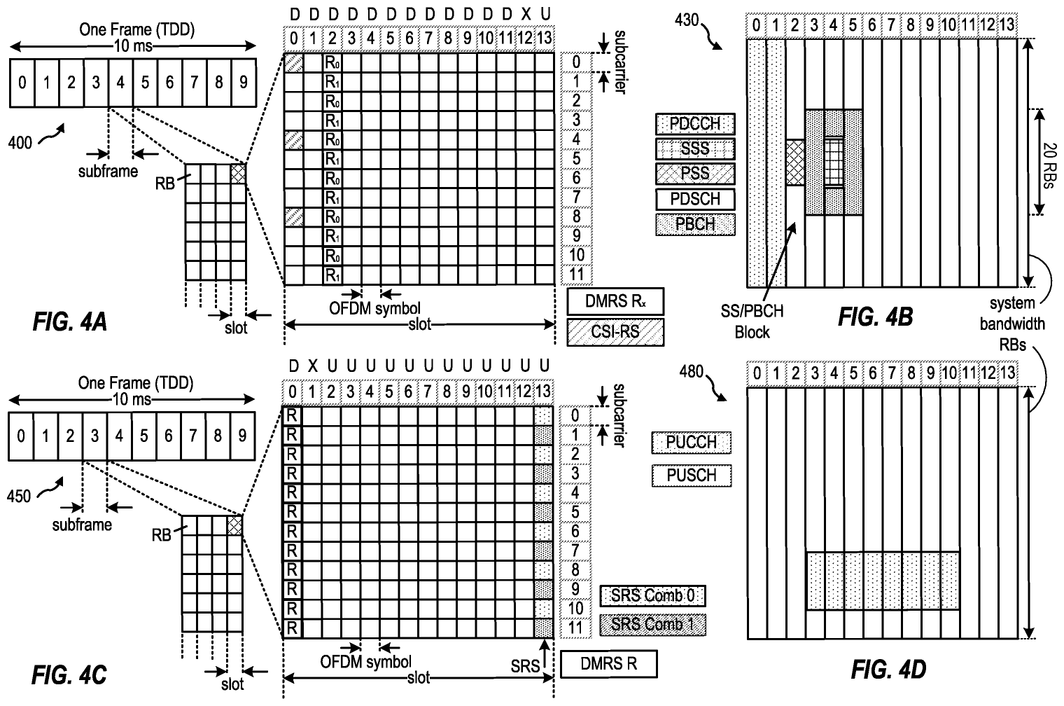

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5GG NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example RACH Procedures

Aspects of the disclosure related to timing advances for random access. A random access channel is so named because it refers to a wireless channel (medium) that may be shared by multiple UEs (e.g., such as UE 104 of FIGS. 1 and 3) and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

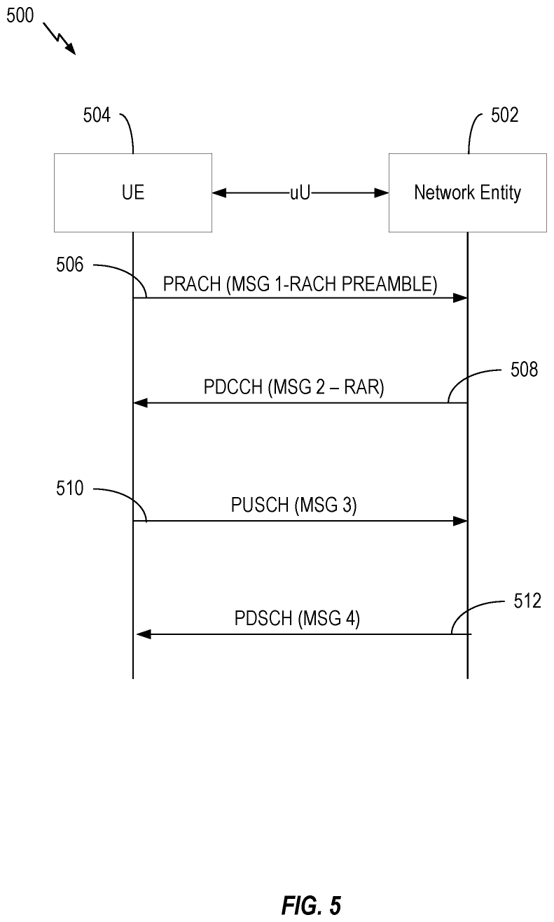

FIG. 5 is a process flow 500 (or a “timing” or “call-flow”) diagram illustrating an example four-step RACH procedure, in accordance with certain aspects of the present disclosure. A first message (MSG1) may be sent from the UE 504 to network entity 502 (such as a BS 102 of FIGS. 1 and 3) on the physical random access channel (PRACH). In this case, MSG1 may only include a RACH preamble. A RACH preamble may include a cyclic prefix (CP), a sequence (e.g., a Zadoff-Chu sequence), and a guard period.

Network entity 502 may respond with a RAR message (MSG 2) which may include the identifier (ID) of the RACH preamble, a timing advance command (TAC), an uplink grant, a temporary cell radio network temporary identifier (TC-RNTI), and a back off indicator.

In response to the MSG2, a MSG3 is transmitted from the UE 504 to network entity 502 on the PUSCH. The MSG3 may include one or more of a RRC connection request, a tracking area update (TAU) request, a system information request, a positioning fix or positioning signal request, UE-ID such as a C-RNTI, medium access control control element (MAC CE), or a scheduling request.

The network entity 502 then responds with MSG 4 which may include a contention resolution message and/or a DCI.

In some cases, to speed up access, a two-step RACH procedure may be supported. As the name implies, the two-step RACH procedure effectively “collapses” the four messages of the four-step RACH procedure into two messages.

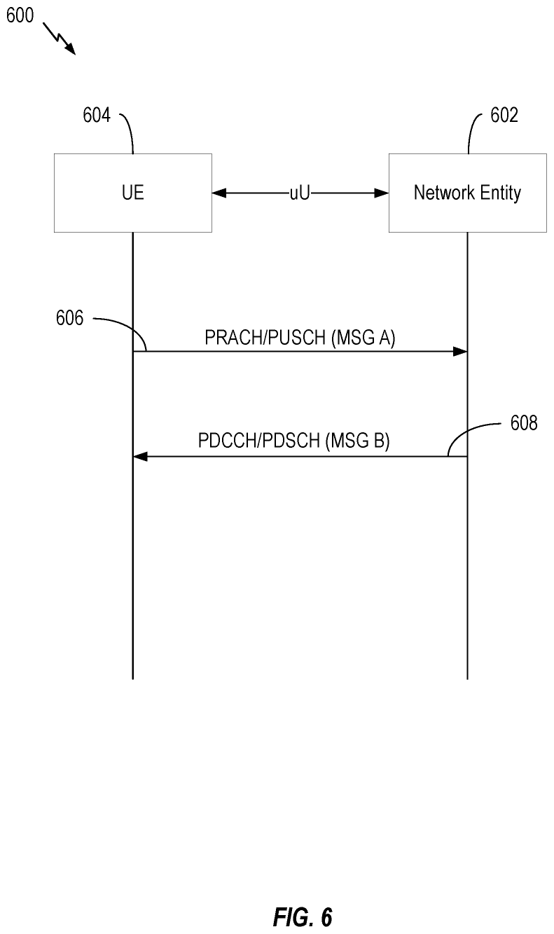

FIG. 6 is a process flow 600 illustrating an example two-step RACH procedure, in accordance with certain aspects of the present disclosure. A first enhanced message (MSGA) may be sent from the UE 604 to network entity 602. The MSGA includes some or all the information from the MSG1 and MSG3 from the four-step RACH procedure, effectively combining the MSG1 and MSG3. For example, MSGA may include MSG1 and MSG3 multiplexed together such as using one of time-division multiplexing or frequency-division multiplexing. MSGA may include a RACH preamble for random access and a payload. The MSGA payload, for example, may include the UE-ID, buffer status report (BSR), RRC connection request, TAU request, system information request, positioning fix or positioning signal request, and/or scheduling request.

Network entity 602 may respond with a RAR message (MSGB) which may effectively combine the MSG2 and MSG4 described above. For example, MSGB may include the ID of the RACH preamble, a TAC, a back off indicator, a contention resolution message, UL/DL grant, and transmit power control (TPC) commands.

### Aspects Related to Timing Advances in Random Access

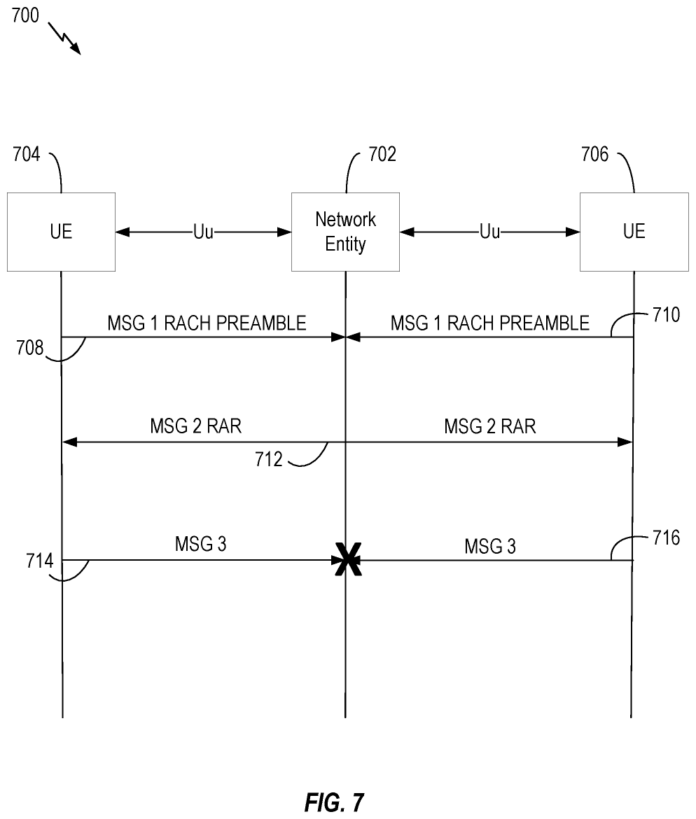

In some cases, RACH preambles from multiple UEs may “collide.” FIG. 7 is a process flow 700 diagram illustrating an example of RACH preamble collision in a four-step RACH procedure. As shown, both UE 704 and UE 706 send a RACH preamble to the network entity 702 at 708 and 710, respectively. The RACH preambles sent by the UE 704 and UE 706 may be identical. That is, UE 704 and UE 706 may generate RACH preambles with the same sequence and transmit the RACH preambles in the same RACH resource and RACH occasion to the network entity 702.

At 712, in response to receiving the MSG 1, the network entity 702 sends a MSG 2 RAR with a resource allocation, MCS, and TAC for a MSG 3. Because the RACH preambles are identical, the UE 704 and the UE 706 receive the same MSG 2.

In response to receiving the same MSG 2, both the UE 704 and the UE 704 transmit MSG 3 to the network entity 702 in the same resource, at 714 and 716, respectively. The MSG 3 transmissions from the UE 704 and the UE 706, thus, may collide at the network entity 702 resulting in a reduced signal to interference noise ratio (SINR), for example, an SINR below 0 dB. The low SINR may result in the network entity 702 failing to successfully receive and decode one or both of the MSG3 transmissions from the one or both UEs and, thus, the network entity 702 may fail to transmit a response (e.g. a MSG4 and/or a DCI) to acknowledge the MSG3 reception to the one or both UEs. When the MSG3 transmission is not successfully received by the network entity 702, the UEs may need to retransmit the MSG3 or may need to transmit both the MSG1 and the MSG3. Accordingly, the system capacity may be limited due to the collision happened during the random access.

It should be noted that while FIG. 7 illustrates two UEs that transmit colliding RACH preambles, any number of UEs may transmit RACH preambles that collide. Non-terrestrial networks (NTN) is one particular example of a scenario in which the random access collision rates may be especially high.

As discussed above, wireless communications network 100 may include terrestrial aspects, such as ground-based network entities (e.g., BSs 102), and non-terrestrial aspects, such as satellite 140 and aircraft 145, which may include network entities on-board (e.g., at least part of one or more BSs) capable of communicating with other network elements (e.g., terrestrial BSs and/or non-terrestrial BSs) and UEs.

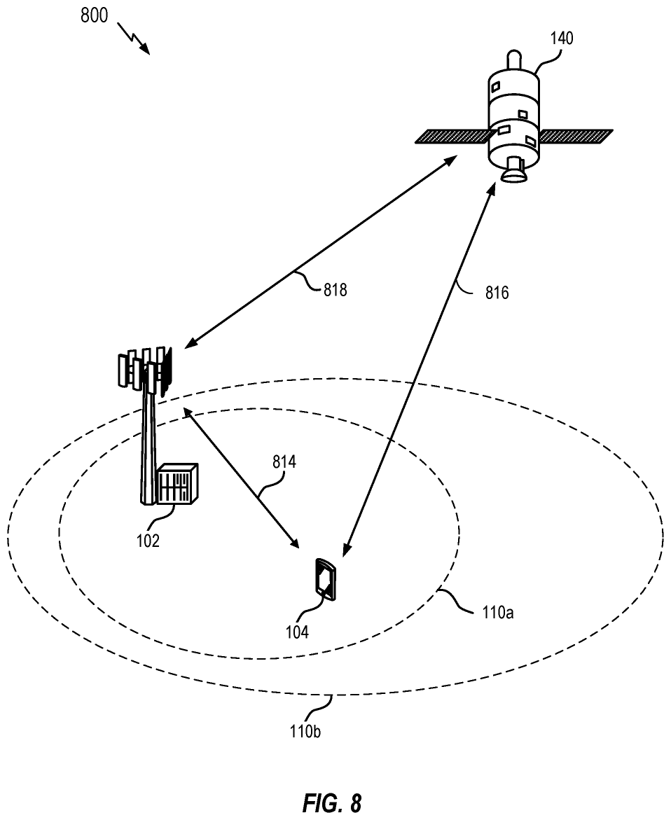

FIG. 8 illustrates an example of a wireless communications network 800 including UEs, an NTN entity and an NTN gateway. In some examples, the wireless communications network 800 may implement aspects of the wireless communication network 100. For example, the wireless communications network 800 may include a BS 102, UE 104, and the satellite 140. BS 102 may serve a coverage area (or cell) 110a in cases of a terrestrial network, and satellite 140 may serve the coverage area 110b in cases of a NTN. Some NTNs may employ airborne platforms (e.g., a drone or balloon) and/or spaceborne platforms (e.g., a satellite). The satellite 140 may communicate with a terrestrial gateway (e.g., a satellite dish) via a feeder link. The BS 102 may co-located with a gateway, deployed behind the gateway, and/or deployed on the satellite 140.

Satellite 140 may communicate with the BS 102 and UE 104 as part of wireless communications in an NTN. The UE 104 may communicate with the BS 102 over a communication link 814. Satellite 140 may be a serving cell for the UE 104 via a communication link 816 referred to as a service link. In certain aspects, the satellite 140 may act as a relay (or a remote radio head) for the BS 102 and the UE 104. For example, the BS 102 may communicate with the satellite 140 via a communication link 818 (referred to as a feeder link), and the non-terrestrial network entity may relay signaling between the BS 102 and UE 104 via the communication links 816 and 818.

An NTN may serve UEs in a rural area. The satellite 140 (or other NTN entity) can serve a very large coverage area 110b. In some cases, UEs in the NTN coverage area 110b communicate using small message, such as using NB Internet-of-Things (IoT). In some cases, these UEs can send a small message in the MSG3/MSGB during random access, referred to as an early data transmission (EDT) or small data transmission (SDT). Because the NTN coverage area 110b is large, there may be many UEs served within the NTN coverage area 110b. Thus, there may be a higher likelihood of RACH preamble collision and missed EDTs.

Accordingly, techniques for random access procedures with reduced collision rates are desirable.

### Example Operations of Entities in a Communications Network

Aspects of the present disclosure provide techniques, apparatus, and computer readable media for random access with reduced collisions.

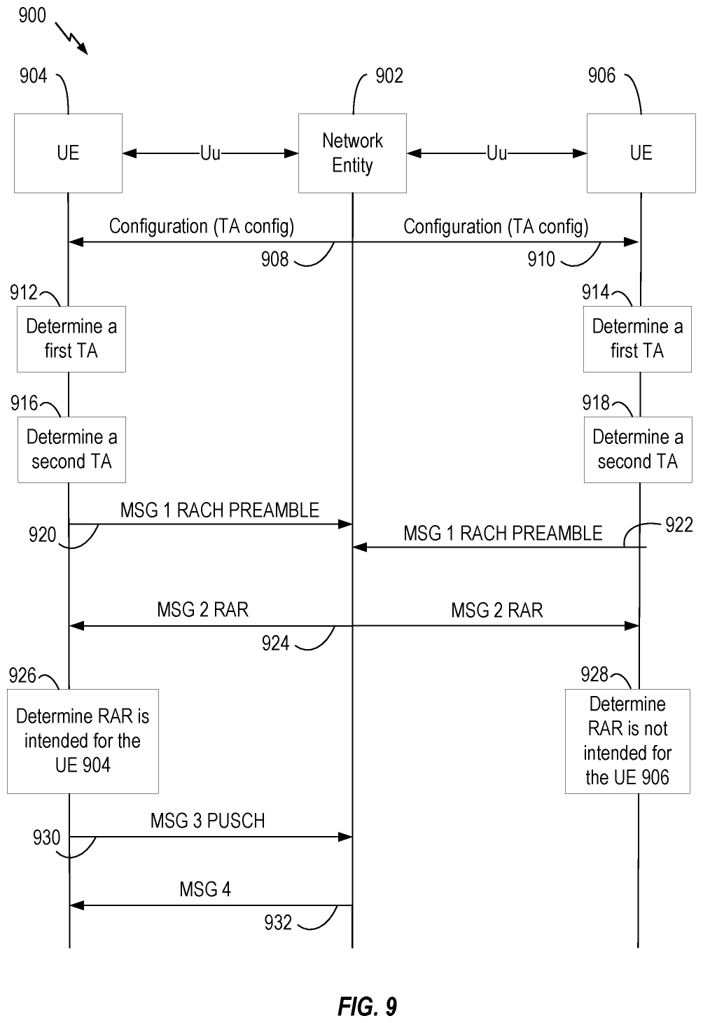

FIG. 9 depicts a process flow 900 diagram illustrating communications in a network between a network entity 902 and a UE 904 and UE 906. In some aspects, the network entity 902 may be an example of the BS 102 depicted and described with respect to FIGS. 1 and 3 or a disaggregated base station depicted and described with respect to FIG. 2. Similarly, the UE 904 and the UE 906 may be an example of UEs 104 depicted and described with respect to FIGS. 1 and 3. However, in other aspects, UE 904 and UE 906 may be another type of wireless communications device and network entity 902 may be another type of network entity or network node, such as those described herein.

As shown, the network entity 902 may configure the UE 904 and the UE 906 with a timing advance configuration. In some aspects, the TA configuration configures a range of timing advances, a range of TA offsets (a) and/or its distribution, a TA value, and/or one or more thresholds. The TA configuration is discussed in more detail below with respect to 916, 918, 926, and 928 of the process flow 900. In some examples, the network entity 902 determines the range of TA offsets and/or its distribution to configure based on a capability of the network entity 902 to decode a RACH preamble. In some examples, the TA configuration configures the range of the second difference between the first and the second TAs or the range of offsets according to uniform distribution. In some examples, the TA configuration may be broadcast, e.g. in SIB, to the UEs or provided to the UEs in RRC signaling.

Although the configuration at 908 and 910 is shown at the same time in FIG. 9, it should be understood that the network entity 902 may configure the UE 904 and the UE 906 at different times.

In some aspects, the TA configuration, or a portion of the TA configuration may be pre-configured, such as hardcoded at the UE 904 and the UE 906, and/or specified in a wireless standard (e.g., a 3GPP technical standard).

The UE 904 determines a first TA, at 912, and the UE 906 determines a first TA at 914. The UE 904 and the UE 906 may determine the first TA according to known TA determination techniques specified the 3GPP wireless standards, e.g. in TS 38.211 and/or TS 38.213. The UE 904 and the UE 906 may determine the first TA based on a location of the UE, ephemeris information associated with an NTN entity (in an NTN network), location of the network entity 902, received TA command(s), and/or one or more common TA parameters. The UE 904 and the UE 906 may determine the first TA to compensate for a round trip time (RTT) between the UE and an uplink synchronization reference point. The uplink synchronization reference point may be determined by the network.

The UE 904 determines a second TA, at 916, and the UE 906 determines a second TA at 918. The UE 904 and the UE 906 may determine their respective second TA based on the configured, or preconfigured, TA configuration. The UE 904 and the UE 906 independently determine a second TA. That is, the UE 904 and the UE 906 may determine different second TAs.

In some examples, both the UE 904 and the UE 906 randomly select the second TA from a configured, or preconfigured, range of TAs. In some examples, both the UE 904 and the UE 906 randomly select an offset (a) value from a configured, or preconfigured, range of offset values. The UE 904 and the UE 906 can each apply the selected offset value to the determined first TA in order to determine the respective second TA. The second TA has a second difference of a with respect to the first TA (e.g., second TA=first TA−σ). Since the first TA is applied by the UE such that the timing of its uplink transmission arriving at the uplink synchronization reference point may align with the uplink slot timing at the uplink synchronization reference point, a effectively contributes to the offset between the timing of the UE's uplink transmission arriving at the uplink synchronization reference point and the uplink slot timing at the uplink synchronization reference point. Thus, if two UEs applies different values of a to transmit their uplinks in the same uplink slot, the signal would arrive at the network entity at different times.

In some examples, the second TA is equal to or smaller than the first TA. A second TA smaller than the first TA may ensure that the TAC, provided by the network entity 902 in the RAR (e.g., in the MSG2 discussed in more detail below with respect to 924 of the process flow 900) is a unipolar value.

At 920, the UE 904 sends a RACH preamble transmission (e.g., MSG1) to the network entity 902 using the second TA determined by the UE 904 at 916. At 922, the UE 906 sends a RACH preamble transmission (e.g., MSG1) to the network entity 902 using the second TA determined by the UE 906 at 918. The RACH preambles transmitted to the network entity 902 by the UE 904 and the UE 906 may collide. That is, as discussed above, the RACH preamble transmitted by the UE 904 and the RACH preamble transmitted by the UE 906 may be identical, having the same RACH preamble sequence and in the same RACH occasion. However, the RACH preambles arrive at the network entity at different times due to the different second TAs determined by the UE 904 and the UE 906. More specifically, the RACH preambles arrive at the network entity at different times due to the different values of a determined by the UE 904 and the UE 906. Accordingly, as discussed in more detail below, the use of the second TA may enable avoidance of a MSG3 collision even where the RACH preambles are identical.

Upon receiving the multiple RACH preambles replicas with a time difference, the network entity 902 determines a TAC based on one of the RACH preambles. At 924, the network entity 902 transmits a MSG2 to the UE 904 and the UE 906 with the TAC. The MSG2 may also include any of the information discussed above with respect to the MSG2 in FIG. 5 and FIG. 7.

Both the UE 904 and the UE 906 may receive the MSG2 transmission. Upon receiving the MSG2 with the TAC, the UE 904 may determine whether the MSG2 is intended for the UE 904 based on the TAC received at 924, the first TA determined at 912, and the second TA determined at 916. For example, the UE 904 may determine whether the MSG2 is intended for the UE 904 based on a first difference of the TA indicated by the received TAC and a second difference between the first TA and the second TA (e.g., TAC−σ, where σ=first TA−second TA). In some examples, the UE 904 determines that the MSG2 is intended for the UE 904 when the first difference is smaller than a threshold, e.g., as shown at 926. Similarly, the UE 906 may determine whether the MSG2 is intended for the UE 906 based on the TAC received at 924, the first TA determined at 914, and the second TA determined at 918. In some examples, the UE 906 determines that the MSG2 is not intended for the UE 906 when the first difference is equal to or larger than the threshold, e.g., as shown at 928.

In some examples, the threshold is configured or preconfigured. For example, the threshold may be configured with the TA configuration at 908 and 910.

In some examples, the threshold may depend on the accuracy of the first TA, determined at 912 and 914. For example, if an orbit propagator model or global navigation satellite system (GNSS) model used by the UE 904 and/or the UE 906 has a low accuracy, the timing advance determined by the UE, e.g. the first TA, which is based on location information of the UE and the satellite, will be less accurate. The model used by the UE may be less accurate, for example, for a low cost UE or a low complexity UE. In this case, the TAC in the MSG2 from the network entity 902 may contain a TA value located within a large range statistically, because the time difference between the RACH preamble arriving at the network entity 902 and the uplink slot timing at the network entity is located within a large range due to the inaccuracy of the TA. Thus, a larger threshold may be used when the TA determined by the UEs is less accurate. In this case, use of the larger threshold may lessen the probability of false detection, where the MSG2 is intended for a UE but the UE considers MSG2 is not intended for the UE due to the first difference between the TA indicated by the received TAC and the second difference between the first TA and the second TA being equal or larger than the threshold (TAC−σ≥threshold).

In some examples, the UE 904, the UE 906, or the network entity 902 may adjust the threshold based on a number of random access attempts. For example, if the UE 904 or the UE 906 performs MSG1 transmission for a threshold (e.g., a configured or preconfigured threshold) number of times and the corresponding MSG2 transmissions are determined as not intended for the UE, then the UE may adjust the threshold. The adjusted threshold may be a larger threshold. In some examples, the UE adjusts the threshold by a configured, or preconfigured, offset from the current threshold.

When the UE 904 determines, at 926, that the MSG2 is intended for the UE 904, then the UE 904 transmits the MSG3 at 930, as shown. The MSG3 may include any of the information discussed above with respect to the MSG3 in FIG. 5 and FIG. 7. On the other hand, when the UE 906 determines, at 928, that the MSG2 is not intended for the UE 906, then the UE 906 does transmit MSG3, as shown in FIG. 9. Accordingly, the UE 904 and the UE 906 do not transmit colliding MSG3 transmissions to the network entity 902, even where the UE 904 and the UE 906 transmitted colliding RACH preamble transmissions to the network entity 902. Thus, the random access procedure may have a reduced collision rate, for example, as compared to the random access procedure illustrated in FIG. 7. The reduced collision rate may enable increased system capacity and, for example, increased number of EDT/SDT transmissions during the random access procedure.

At 932, network entity 902 transmit a MSG4 to the UE 904. The MSG4 may include any of the information discussed above with respect to the MSG4 in FIG. 5 including contention resolution. In some examples, alternatively or additionally, network entity 902 may transmit a DCI to the UE 904.

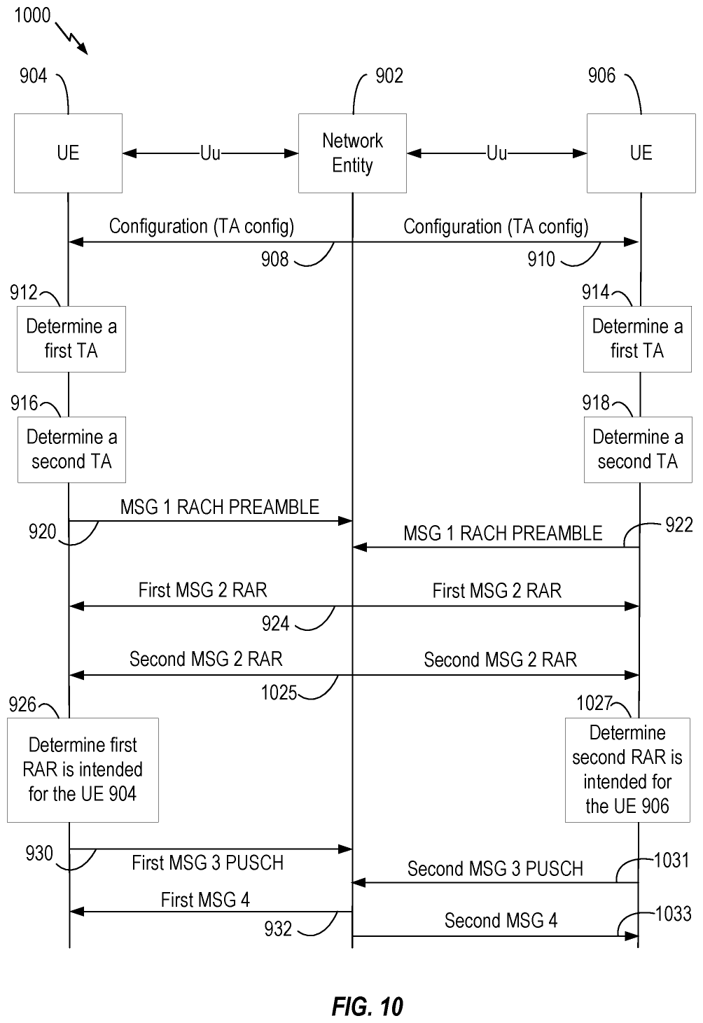

According to certain aspects, the network entity 902 can transmit multiple MSG2 transmissions when the network entity 902 detects identical RACH preambles but with a time difference (e.g., due to different second TAs and/or a values used for the RACH preambles, as described herein), as illustrated in the process flow 1000 in FIG. 10. As shown, based on receiving the two identical RACH preambles at 920 and 922 with a time difference, the network entity 902 transmits the first MSG2 at 924 and also a second MSG2 at 1025. The first MSG2 at 924 and the second MSG2 at 1025 include different TACs, e.g. corresponding to two different timing offsets detected by the network entity 902 from receiving the RACH preamble, and may also include different UL grants, and different temporary cell radio network temporary identifiers (TC-RNTIs). The first MSG2 at 924 and the second MSG2 at 1025 may include the same random access RNTI (RA-RNTI) and/or the same RA preamble identifier (RAPID).

The UE 904 and the 906 monitor and receive both the first MSG2 transmission at 924 and the second MSG2 transmission at 1015 and determine whether the MSG2 transmissions are intended for the UEs as described above with respect to FIG. 9.

As shown, the UE 904 determines, at 926, that the first MSG2 RAR is intended for the UE 904. The UE 904 determines (not shown) that the second MSG2 RAR is not intended for the UE 904. Accordingly, the UE 904 transmits the first MSG3 PUSCH at 930 using the information (e.g. TAC and uplink grant) indicated in the first MSG2 RAR and monitors the first MSG4 from the network entity at 921 based on the information indicated in the first MSG2 RAR, e.g. TC-RNTI in the first MSG2 RAR.

As shown, the UE 906 determines, at 1027, that the second MSG2 RAR is intended for the UE 906. The UE 906 determines (not shown) that the first MSG2 RAR is not intended for the UE 906. Accordingly, the UE 906 transmits the second MSG3 PUSCH at 1031 using the information (e.g. TAC and uplink grant) indicated in the second MSG2 RAR and monitors the second MSG4 from the network entity at 1031 based on the information indicated in the second MSG2 RAR, e.g. TC-RNTI in the second MSG2 RAR.

Accordingly, the MSG3 transmissions by the UE 904 and the UE 906, at 930 and 1031, respectively, do not collide at the network entity 902 due to the different uplink grants in the two MSG2 transmissions.

According to certain aspects, the UE 904 and the UE 906 monitors an entire response window, even after the UE receives a MSG2 for the preamble and the RA-RNTI associated to the transmitted RACH preamble in MSG1 during the response window. The response window may be configured (e.g., via an RRC parameter, ra-Response Window) or preconfigured.

According to certain aspects, if the network entity 902 does not receive a MSG3, in response to a resource allocation contained in a MSG2 for one of the UEs, the network entity 902 may or may not schedule a MSG3 retransmission.

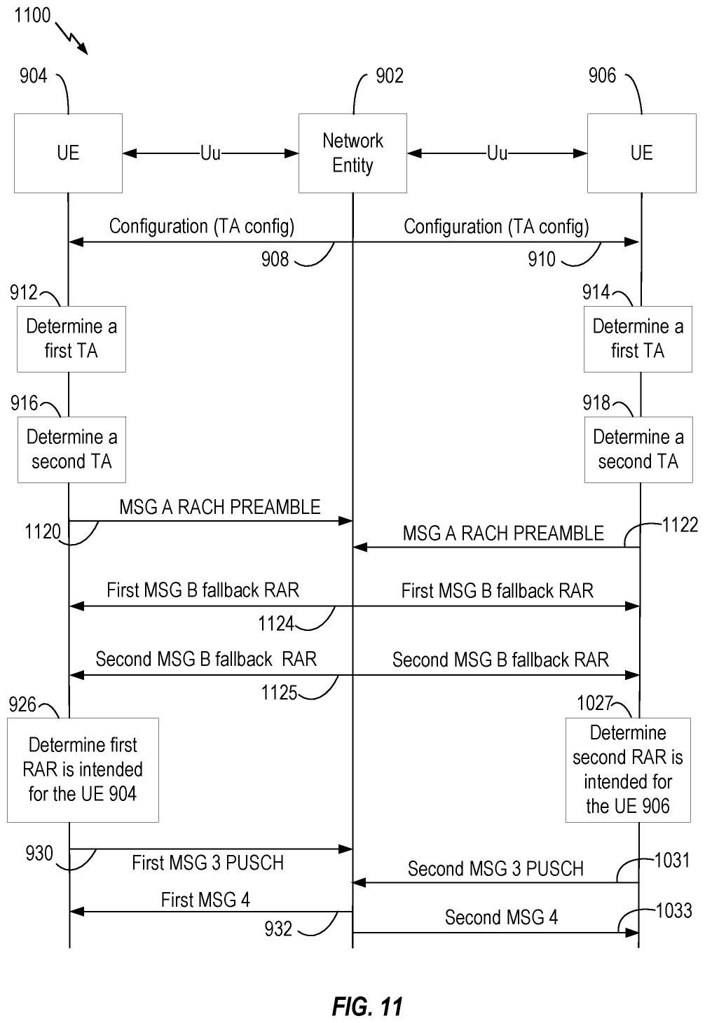

It should be understood that while FIGS. 9-10 are described with respect to a four-step RACH procedure, the aspects described herein also apply to a two-step RACH procedure, as shown in the process flow 1100 illustrated in FIG. 11. For the case of the two-step RACH procedure, the steps 908, 910, 912, 914, 916, and 918 may be performed as described above with respect to the four-step RACH procedure in FIG. 10. At 1120 and 1122, respectively, the UE 904 and the UE 906 transmit the RACH preamble in a MSGA transmission using the second TAs determined at 916 and 918, respectively. The MSGA transmission is described above with respect to step 606 in FIG. 6. At 1124 and 1125, respectively, the network entity 902 transmits a first fallback RAR and a second fallback RAR in a first MSGB transmission and a second MSGB transmission. The MSGB transmission is described above with respect to step 608 in FIG. 6. The fallback RAR may be sent in a medium access control (MAC) sub protocol data unit (PDU). The first fallback RAR and the second fallback RAR carry different TACs and may carry different UL grants and/or different C-RNTI or different TC-RNTI.

According to certain aspects, the UE 904 and the UE 906 monitors an entire response window for receiving MSGB, even after the UE receives a MSGB for the preamble and the RA-RNTI associated to the transmitted RACH preamble in MSGA during the response window. The response window may be configured (e.g., via an RRC parameter, msgB-Response Window) or preconfigured.

The UE 904 and the UE 906 determine whether the first and second RAR are intended for the UEs, at 926 and 1027, respectively, as described above with respect to FIG. 10. In MSGB, the fallback RAR indicates to the UE to fallback to the four-step RACH procedure for transmitting MSG3 and monitoring MSG4. Accordingly, when the UE determines a fallback RAR is intended for the UE, the UE falls back to the four-step RACH and transmits a MSG3, as shown at 930 and 1031, respectively, and monitors MSG4 at 932 and 1033, respectively.

It should be understood that while FIGS. 9-11 illustrates two UEs (904 and 906) that transmit colliding RACH preambles, the aspects described herein may apply to any number of UEs.

### Example Operations of a User Equipment

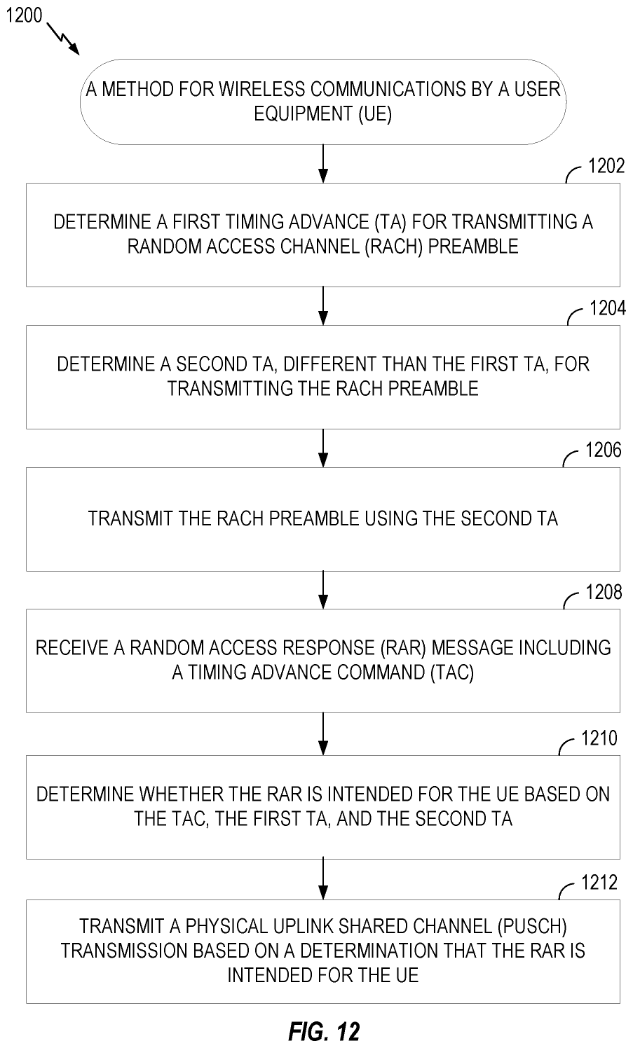

FIG. 12 shows a method 1200 for wireless communications by a UE, such as UE 104 of FIGS. 1 and 3.

Method 1200 begins at 1202 with determining a first TA for transmitting a RACH preamble.

Method 1200 then proceeds to step 1204 with determining a second TA, different than the first TA, for transmitting the RACH preamble.

Method 1200 then proceeds to step 1206 with transmitting the RACH preamble using the second TA.

Method 1200 then proceeds to step 1208 with receiving a RAR message including a TAC.

Method 1200 then proceeds to step 1210 with determining whether the RAR is intended for the UE based on the TAC, the first TA, and the second TA.

Method 1200 then proceeds to step 1212 with transmitting a PUSCH transmission based on a determination that the RAR is intended for the UE.

In one aspect, method 1200 further includes refraining from transmitting a PUSCH based on a determining that the RAR is not intended for the UE.

In one aspect, determining the second TA, at 1204, includes receiving a configuration or preconfiguration for determining the second TA and determining the second TA based on the configuration or preconfiguration. In one aspect, the configuration for determining the second TA comprises a range of offsets and determining the second TA based on the configuration includes selecting an offset from the range of offsets and applying the offset to the first TA to determine the second TA. In one aspect, selecting the offset from the range of offsets comprises randomly selecting the offset from the range of offsets.

In one aspect, the second TA is equal to or smaller than the first TA.

In one aspect, determining whether the RAR is intended for the UE, at 1210, includes determining the RAR is intended for the UE when a first difference is smaller than a threshold. The first difference is a difference between the TAC and a second difference. The second difference is a difference between the first TA and the second TA. Determining whether the RAR is intended for the UE, at 1210, includes determining the RAR is not intended for the UE when the first difference is equal to or greater than the threshold.

In one aspect, method 1200 further includes receiving signaling configuring the threshold at the UE.

In one aspect, method 1200 further includes determining the threshold based on a character associated to the first TA.

In one aspect, method 1200 further includes adjusting the threshold based on a number of random access attempts.

In one aspect, adjusting the threshold based on the number of random access attempts includes adjusting the threshold after determining a configured threshold number of RARs are not intended for the UE.

In one aspect, method 1200 further includes receiving a second RAR, after transmitting the RACH preamble and before transmitting the PUSCH, including a second TAC. In one aspect, the method 1200 further includes determining the second RAR is not intended for the UE based on a third difference between the second TAC and the second difference between the first TA and the second TA.

In one aspect, the RAR includes a RA-RNTI, a RAPID, or both and the second RAR includes the same RA-RNTI, the same RAPID, or both.

In one aspect, transmitting the RACH preamble, at 1206, includes transmitting a RACH message and a PUSCH. In one aspect, receiving the RAR, at 1208, includes receiving a fallback RAR in a RACH message.

In one aspect, method 1200 further includes monitoring an entire configured RAR window, wherein one or multiple RAR is received in the RAR window.

In one aspect, determining the first TA includes determining the first TA based on a location of the UE, ephemeris information, one or more configured common TA parameters, or a combination thereof.

In one aspect, the RACH preamble transmission and the PUSCH transmission includes a NB-IoT EDT or SDT.

In one aspect, the UE performs a RACH procedure with a NTN.

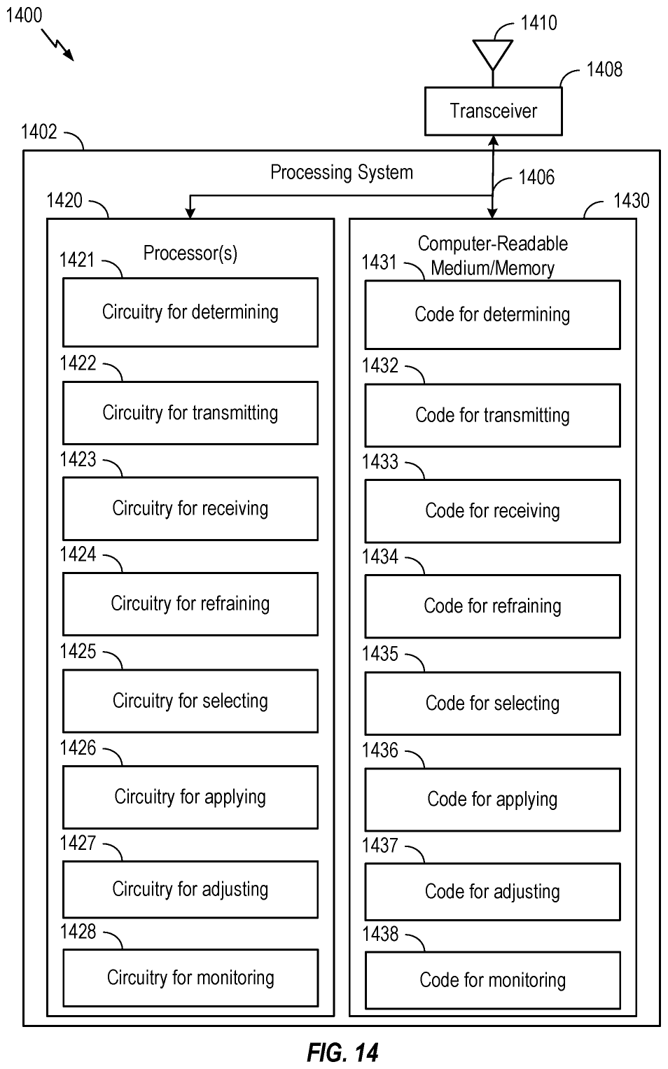

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

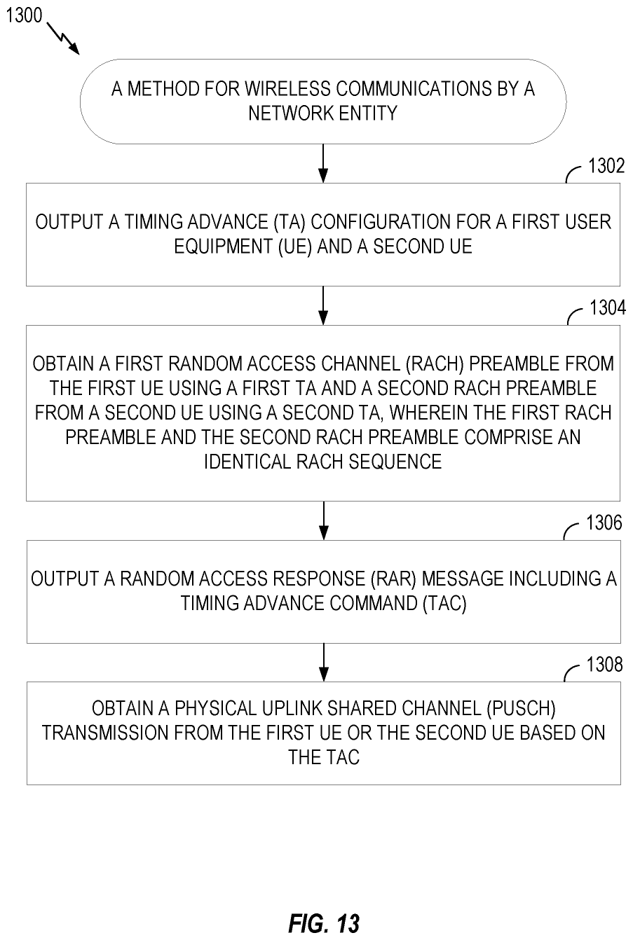

FIG. 13 shows a method 1300 for wireless communications by a network entity, such as BS 102 of FIGS. 1 and 3, or a disaggregated base station as discussed with respect to FIG. 2.

Method 1300 begins at 1302 with outputting a timing advance (TA) configuration for a first UE and a second UE.

Method 1300 then proceeds to step 1304 with obtaining a first RACH preamble from the first UE using a first TA and a second RACH preamble from the second UE using a second TA. The first RACH preamble and the second RACH preamble comprise an identical RACH sequence.

Method 1300 then proceeds to step 1306 with outputting a RAR message including a TAC.

Method 1300 then proceeds to step 1308 with obtaining a PUSCH transmission from the first UE or the second UE based on the TAC.

In one aspect, the first RACH preamble and the second RACH preamble are obtained at different times.

In one aspect, the TA configuration comprises a range of offsets or a range of TA values.

In one aspect, method 1300 further includes determining the range of offsets or the range of TA values based on a capability of the network entity to decode a RACH preamble.

In one aspect, method 1300 further includes outputting a threshold, wherein the threshold comprises a threshold difference for each of the first UE and the second UE to determine whether the RAR message is intended for the UE. The threshold difference is between a first difference and a second difference. The first difference is a difference between the TAC and the second difference. The second difference is a TA difference. The TA difference is a difference between the first TA and a third TA of the first UE and a difference between the second TA and a fourth TA of the second UE.

In one aspect, method 1300 further includes determining the threshold based on a character associated to the first TA.

In one aspect, method 1300 further includes outputting a second RAR, after obtaining the RACH preamble and before obtaining the PUSCH, including a second TAC, different than the TAC.

In one aspect, the RAR comprises a access radio network temporary identifier (RA-RNTI), a random access preamble identifier (RAPID), or both and the second RAR comprises the same RA-RNTI, the same RAPID, or both.

In one aspect, obtaining the RACH preamble, at 1304, comprises obtaining a RACH message further comprising a PUSCH and outputting the RAR, at 1306, comprises outputting a fallback RAR in a RACH message.

In one aspect, the RACH preamble transmission and the PUSCH transmission comprises a NB-IoT EDT or SDT.

In one aspect, the network entity is a NTN entity or communicates with the NTN entity.

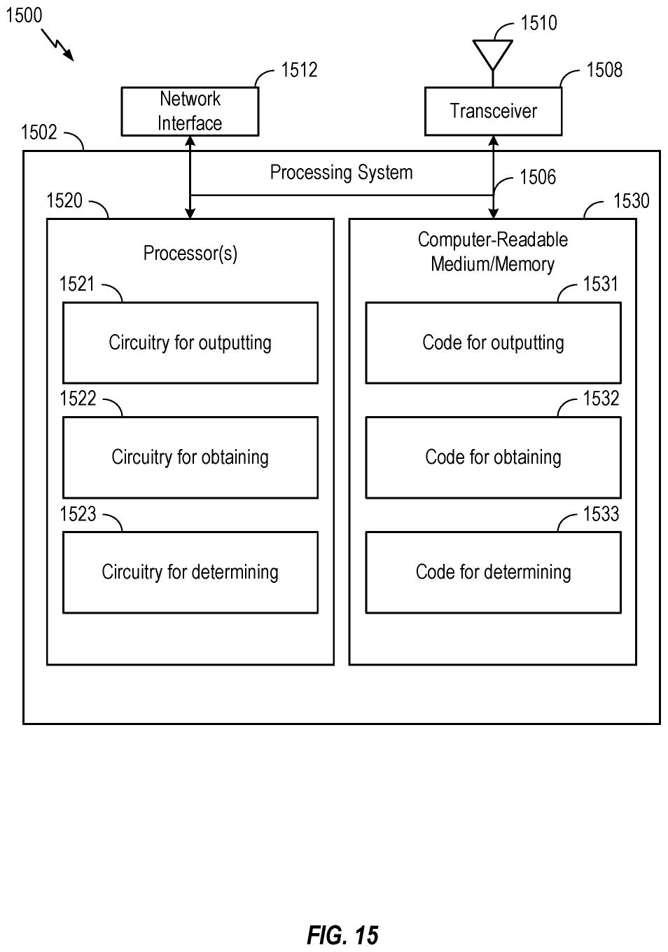

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 358, transmit processor 364, TX MIMO processor 366, and/or controller/processor 380, as described with respect to FIG. 3. The one or more processors 1420 are coupled to a computer-readable medium/memory 1430 via a bus 1406. In certain aspects, the computer-readable medium/memory 1430 is configured to store instructions (e.g., computer-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

In the depicted example, computer-readable medium/memory 1430 stores code (e.g., executable instructions) for determining 1431, code for transmitting 1432, code for receiving 1433, code for refraining 1434, code for selecting 1435, code for applying 1436, code for adjusting 1437, and code for monitoring 1438. Processing of the code 1431-1438 may cause the communications device 1400 to perform the method 1200 described with respect to FIG. 12, or any aspect related to it.

The one or more processors 1420 include circuitry configured to implement (e.g., execute) the code stored in the computer-readable medium/memory 1430, including circuitry for determining 1421, circuitry for transmitting 1422, circuitry for receiving 1423, circuitry for refraining 1424, circuitry for selecting 1425, circuitry for applying 1426, circuitry for adjusting 1427, and circuitry for monitoring 1428. Processing with circuitry 1421-1428 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include the transceivers 354 and/or antenna(s) 352 of the UE 104 illustrated in FIG. 3 and/or transceiver 1408 and antenna 1410 of the communications device 1400 in FIG. 14. Means for receiving or obtaining may include the transceivers 354 and/or antenna(s) 352 of the UE 104 illustrated in FIG. 3 and/or transceiver 1408 and antenna 1410 of the communications device 1400 in FIG. 14.

FIG. 15 depicts aspects of an example communications device. In some aspects, communications device 1500 is a network entity, such as BS 102 of FIGS. 1 and 3, or a disaggregated base station as discussed with respect to FIG. 2.

The communications device 1500 includes a processing system 1502 coupled to a transceiver 1508 (e.g., a transmitter and/or a receiver) and/or a network interface 1512. The transceiver 1508 is configured to transmit and receive signals for the communications device 1500 via an antenna 1510, such as the various signals as described herein. The network interface 1512 is configured to obtain and send signals for the communications device 1500 via communications link(s), such as a backhaul link, midhaul link, and/or fronthaul link as described herein, such as with respect to FIG. 2. The processing system 1502 may be configured to perform processing functions for the communications device 1500, including processing signals received and/or to be transmitted by the communications device 1500.

The processing system 1502 includes one or more processors 1520. In various aspects, one or more processors 1520 may be representative of one or more of receive processor 338, transmit processor 320, TX MIMO processor 330, and/or controller/processor 340, as described with respect to FIG. 3. The one or more processors 1520 are coupled to a computer-readable medium/memory 1530 via a bus 1506. In certain aspects, the computer-readable medium/memory 1530 is configured to store instructions (e.g., computer-executable code) that when executed by the one or more processors 1520, cause the one or more processors 1520 to perform the method 1300 described with respect to FIG. 13, or any aspect related to it. Note that reference to a processor of communications device 1500 performing a function may include one or more processors of communications device 1500 performing that function.

In the depicted example, the computer-readable medium/memory 1530 stores code (e.g., executable instructions) for outputting 1531, code for obtaining 1532, and code for determining 1533. Processing of the code 1531-1533 may cause the communications device 1500 to perform the method 1300 described with respect to FIG. 13, or any aspect related to it.

The one or more processors 1520 include circuitry configured to implement (e.g., execute) the code stored in the computer-readable medium/memory 1530, including circuitry for outputting 1521, circuitry for obtaining 1522, and circuitry for determining 1523. Processing with circuitry 1521-1523 may cause the communications device 1500 to perform the method 1300 as described with respect to FIG. 13, or any aspect related to it.

Various components of the communications device 1500 may provide means for performing the method 1300 as described with respect to FIG. 3, or any aspect related to it. Means for transmitting, sending or outputting for transmission may include the transceivers 332 and/or antenna(s) 334 of the BS 102 illustrated in FIG. 3 and/or transceiver 1508 and antenna 1510 of the communications device 1500 in FIG. 15. Means for receiving or obtaining may include the transceivers 332 and/or antenna(s) 334 of the BS 102 illustrated in FIG. 3 and/or transceiver 1508 and antenna 1510 of the communications device 1500 in FIG. 15.

### Example Clauses

Implementation examples are described in the following numbered clauses:
Clause 1: A method for wireless communications by a user equipment (UE), comprising: determining a first timing advance (TA) for transmitting a random access channel (RACH) preamble; determining a second TA, different than the first TA, for transmitting the RACH preamble; transmitting the RACH preamble using the second TA; receiving a random access response (RAR) message including a timing advance command (TAC); determining whether the RAR is intended for the UE based on the TAC, the first TA, and the second TA; and transmitting a physical uplink shared channel (PUSCH) transmission based on a determination that the RAR is intended for the UE.
Clause 2: The method of Clause 1, further comprising: refraining from transmitting a PUSCH based on a determining that the RAR is not intended for the UE.
Clause 3: The method of any one or more of Clauses 1-2, wherein determining the second TA comprises: receiving a configuration or preconfiguration for determining the second TA; and determining the second TA based on the configuration or preconfiguration.
Clause 4: The method of Clause 3, wherein: the configuration for determining the second TA comprises a range of offsets; and determining the second TA based on the configuration comprises: selecting an offset from the range of offsets: and applying the offset to the first TA to determine the second TA.
Clause 5: The method of Clause 4, wherein selecting the offset from the range of offsets comprises randomly selecting the offset from the range of offsets.
Clause 6: The method of any one or more of Clauses 1-5, wherein the second TA is equal to or smaller than the first TA.
Clause 7: The method of any one or more of Clauses 1-6, wherein determining whether the RAR is intended for the UE comprises: determining the RAR is intended for the UE when a first difference is smaller than a threshold, wherein the first difference is a difference between the TAC and a second difference, and wherein the second difference is a difference between the first TA and the second TA; and determining the RAR is not intended for the UE when the first difference is equal to greater than the threshold.
Clause 8: The method of Clause 7, further comprising receiving signaling configuring the threshold at the UE.
Clause 9: The method of any one or more of Clauses 7-8, further comprising determining the threshold based on a character associated to the first TA.
Clause 10: The method of any one or more of Clauses 7-9, further comprising adjusting the threshold based on a number of random access attempts.
Clause 11: The method of Clause 10, wherein adjusting the threshold based on the number of random access attempts comprises adjusting the threshold after determining a configured threshold number of RARs are not intended for the UE.
Clause 12: The method of any one or more of Clauses 1-11, further comprising: receiving a second RAR, after transmitting the RACH preamble and before transmitting the PUSCH, including a second TAC; and determining the second RAR is not intended for the UE based on a third difference between the second TAC and a second difference between the first TA and the second TA.
Clause 13: The method of claim 12, wherein: the RAR comprises a access radio network temporary identifier (RA-RNTI), a random access preamble identifier (RAPID), or both; and the second RAR comprises the same RA-RNTI, the same RAPID, or both.
Clause 14: The method of any one or more of Clauses 1-13, wherein: transmitting the RACH preamble comprises transmitting a RACH message further comprising a PUSCH; and receiving the RAR comprises receiving a fallback RAR in a RACH message.
Clause 15: The method of any one or more of Clauses 1-14, further comprising: monitoring an entire configured RAR window, wherein one or multiple RAR is received in the RAR window.
Clause 16: The method of any one or more of Clauses 1-15, wherein determining the first TA comprises: determining the first TA based on a location of the UE, ephemeris information, one or more configured common TA parameters, or a combination thereof.
Clause 17: The method of any one or more of Clauses 1-16, wherein the RACH preamble transmission and the PUSCH transmission comprises a narrowband Internet-of-Thing (NB-IoT) early data transmission (EDT) or small data transmission (SDT.
Clause 18: The method of any one or more of Clauses 1-17, wherein the UE performs a RACH procedure with a non-terrestrial network (NTN).
Clause 19: A method for wireless communications by a network entity, comprising: outputting a timing advance (TA) configuration for a first user equipment (UE) and a second UE; obtaining a first random access channel (RACH) preamble from the first UE using a first TA and a second RACH preamble from the second UE using a second TA, wherein the first RACH preamble and the second RACH preamble comprise an identical RACH sequence; outputting a random access response (RAR) message including a timing advance command (TAC); and obtaining a physical uplink shared channel (PUSCH) transmission from the first ULE or the second UE based on the TAC.
Clause 20: The method of Clause 19, wherein the first RACH preamble and the second RACH preamble are obtained at different times.
Clause 21: The method of any one or more of Clauses 19-20, wherein the TA configuration comprises a range of offsets or a range of TA values.
Clause 22: The method of Clause 21, further comprising determining the range of offsets or the range of TA values based on a capability of the network entity to decode a RACH preamble.
Clause 23: The method of any one or more of Clauses 19-22, further comprising outputting a threshold, wherein the threshold comprises a threshold difference between the TAC and a TA difference for each of the first UE and the second UE to determine whether the RAR message is intended for the UE.
Clause 24: The method of Clause 23, further comprising determining the threshold based on a character associated to the first TA.
Clause 25: The method of any one or more of Clauses 19-24, further comprising: outputting a second RAR, after obtaining the RACH preamble and before obtaining the PUSCH, including a second TAC, different than the TAC.
Clause 26: The method of Clause 25, wherein: the RAR comprises a access radio network temporary identifier (RA-RNTI), a random access preamble identifier (RAPID), or both; and the second RAR comprises the same RA-RNTI, the same RAPID, or both.
Clause 27: The method of any one or more of Clauses 19-26, wherein: obtaining the RACH preamble comprises obtaining a RACH message further comprising a PUSCH; and outputting the RAR comprises outputting a fallback RAR in a RACH message.
Clause 28: The method of any one or more of Clauses 19-27, wherein the RACH preamble transmission and the PUSCH transmission comprises a narrowband Internet-of-Thing (NB-IoT) early data transmission (EDT) or small data transmission (SDT).
Clause 29: The method of any one or more of Clauses 19-28, wherein the network entity is a non-terrestrial network (NTN) entity or communicates with the NTN entity.
Clause 30: An apparatus, comprising: a memory comprising executable instructions; and a processor configured to execute the executable instructions and cause the apparatus to perform a method in accordance with any one of Clauses 1-29.
Clause 31: An apparatus, comprising means for performing a method in accordance with any one of Clauses 1-29.
Clause 32: A non-transitory computer-readable medium comprising executable instructions that, when executed by a processor of an apparatus, cause the apparatus to perform a method in accordance with any one of Clauses 1-29.
Clause 33: A computer program product embodied on a computer-readable storage medium comprising code for performing a method in accordance with any one of Clauses 1-29.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: a memory comprising computer-executable instructions; and a processor configured to execute the computer-executable instructions and cause the apparatus to:
determine a first timing advance (TA) for transmitting a random access channel (RACH) preamble;
determine a second TA, different than the first TA, for transmitting the RACH preamble;
transmit the RACH preamble using the second TA;
receive a random access response (RAR) message including a timing advance command (TAC);
determine whether the RAR is intended for the apparatus based on the TAC, the first TA, and the second TA; and
transmit a physical uplink shared channel (PUSCH) transmission based on a determination that the RAR is intended for the apparatus.

2. The apparatus of claim 1, wherein the processor is configured to execute the computer-executable instructions and further cause the apparatus to:
refrain from transmitting a PUSCH based on a determining that the RAR is not intended for the apparatus.

3. The apparatus of claim 1, wherein the processor being configured to execute the computer-executable instructions and cause the apparatus to determine the second TA comprises the processor being configured to execute the computer-executable instructions and cause the apparatus to:
receive a configuration or preconfiguration for determining the second TA; and
determine the second TA based on the configuration or preconfiguration.

4. The apparatus of claim 3, wherein:
the configuration for determining the second TA comprises a range of offsets; and
the processor being configured to execute the computer-executable instructions and cause the apparatus to determine the second TA based on the configuration comprises the processor being configured to execute the computer-executable instructions and cause the apparatus to:
select an offset from the range of offsets: and
apply the offset to the first TA to determine the second TA.

5. The apparatus of claim 4, wherein the processor being configured to execute the computer-executable instructions and cause the apparatus to select the offset from the range of offsets comprises the processor being configured to execute the computer-executable instructions and cause the apparatus to
randomly select the offset from the range of offsets.

6. The apparatus of claim 1, wherein the second TA is equal to or smaller than the first TA.

7. The apparatus of claim 1, wherein the processor being configured to execute the computer-executable instructions and cause the apparatus to determine whether the RAR is intended for the apparatus comprises the processor being configured to execute the computer-executable instructions and cause the apparatus to:
determine the RAR is intended for the apparatus when a first difference is smaller than a threshold, wherein the first difference is a difference between the TAC and a second difference between the first TA and the second TA; and
determine the RAR is not intended for the apparatus when the first difference is equal to or greater than the threshold.

8. The apparatus of claim 7, wherein the processor is configured to execute the computer-executable instructions and further cause the apparatus to receive signaling configuring the threshold at the apparatus.

9. The apparatus of claim 7, wherein the processor is configured to execute the computer-executable instructions and further cause the apparatus to determine the threshold based on a character associated to the first TA.

10. The apparatus of claim 7, wherein the processor is configured to execute the computer-executable instructions and further cause the apparatus to adjust the threshold based on a number of random access attempts.

11. The apparatus of claim 10, wherein adjusting the threshold based on the number of random access attempts comprises adjusting the threshold after determining a configured threshold number of RARs are not intended for the apparatus.

12. The apparatus of claim 1, wherein the processor is configured to execute the computer-executable instructions and further cause the apparatus to:
receive a second RAR, after transmitting the RACH preamble and before transmitting the PUSCH, including a second TAC; and
determine the second RAR is not intended for the apparatus based on a third difference, wherein the third difference is a difference between the second TAC and a second difference between the first TA and the second TA.

13. The apparatus of claim 12, wherein:
the RAR comprises a access radio network temporary identifier (RA-RNTI), a random access preamble identifier (RAPID), or both; and
the second RAR comprises the same RA-RNTI, the same RAPID, or both.

14. The apparatus of claim 1, wherein:
transmitting the RACH preamble comprises transmitting a RACH message further comprising a PUSCH; and
receiving the RAR comprises receiving a fallback RAR in a RACH message.

15. The apparatus of claim 1, wherein the processor is configured to execute the computer-executable instructions and further cause the apparatus to:
monitor an entire configured RAR window, wherein one or multiple RAR is received in the RAR window.

16. The apparatus of claim 1, wherein determining the first TA comprises:
determining the first TA based on a location of the apparatus, ephemeris information, one or more configured common TA parameters, or a combination thereof.

17. The apparatus of claim 1, wherein the RACH preamble transmission and the PUSCH transmission comprises a narrowband Internet-of-Thing (NB-IoT) early data transmission (EDT) or small data transmission (SDT.

18. The apparatus of claim 1, wherein the UE performs a RACH procedure with a non-terrestrial network (NTN).

19. An apparatus configured for wireless communications, comprising: a memory comprising computer-executable instructions; and a processor configured to execute the computer-executable instructions and cause the apparatus to:
output a timing advance (TA) configuration for a first user equipment (UE) and a second UE;
obtain a first random access channel (RACH) preamble from the first UE using a first TA and a second RACH preamble from the second UE using a second TA, wherein the first RACH preamble and the second RACH preamble comprise an identical RACH sequence;
output a random access response (RAR) message including a timing advance command (TAC); and
obtain a physical uplink shared channel (PUSCH) transmission from the first UE or the second UE based on the TAC.

20. The apparatus of claim 19, wherein the first RACH preamble and the second RACH preamble are obtained at different times.

21. The apparatus of claim 19, wherein the TA configuration comprises a range of offsets or a range of TA values.

22. The apparatus of claim 21, wherein the processor is configured to execute the computer-executable instructions and further cause the apparatus to:
determine the range of offsets or the range of TA values based on a capability of the apparatus to decode a RACH preamble.

23. The apparatus of claim 19, wherein the processor is configured to execute the computer-executable instructions and further cause the apparatus to:
output a threshold, wherein the threshold comprises a threshold difference between the TAC and a TA difference for each of the first UE and the second UE to determine whether the RAR message is intended for the UE.

24. The apparatus of claim 23, wherein the processor is configured to execute the computer-executable instructions and further cause the apparatus to:
determine the threshold based on a character associated to the first TA.

25. The apparatus of claim 19, wherein the processor is configured to execute the computer-executable instructions and further cause the apparatus to:
output a second RAR, after obtaining the RACH preamble and before obtaining the PUSCH, including a second TAC, different than the TAC.

26. The apparatus of claim 25, wherein:
the RAR comprises a access radio network temporary identifier (RA-RNTI), a random access preamble identifier (RAPID), or both; and
the second RAR comprises the same RA-RNTI, the same RAPID, or both.

27. The apparatus of claim 19, wherein:
the processor being configured to execute the computer-executable instructions and cause the apparatus to obtain the RACH preamble comprises the processor being configured to execute the computer-executable instructions and cause the apparatus to obtain a RACH message further comprising a PUSCH; and
the processor being configured to execute the computer-executable instructions and cause the apparatus to output the RAR comprises the processor being configured to execute the computer-executable instructions and cause the apparatus to output a fallback RAR in a RACH message.

28. The apparatus of claim 19, wherein the RACH preamble transmission and the PUSCH transmission comprises a narrowband Internet-of-Thing (NB-IoT) early data transmission (EDT) or small data transmission (SDT).

29. A method for wireless communications by a user equipment (UE), comprising:
determining a first timing advance (TA) for transmitting a random access channel (RACH) preamble;
determining a second TA, different than the first TA, for transmitting the RACH preamble;
transmitting the RACH preamble using the second TA;
receiving a random access response (RAR) message including a timing advance command (TAC);
determining whether the RAR is intended for the UE based on the TAC, the first TA, and the second TA; and
transmitting a physical uplink shared channel (PUSCH) transmission based on a determination that the RAR is intended for the UE.

30. A method for wireless communications by a network entity, comprising:
outputting a timing advance (TA) configuration for a first user equipment (UE) and a second UE;
obtaining a first random access channel (RACH) preamble from the first UE using a first TA and a second RACH preamble from the second UE using a second TA, wherein the first RACH preamble and the second RACH preamble comprise an identical RACH sequence;
outputting a random access response (RAR) message including a timing advance command (TAC); and
obtaining a physical uplink shared channel (PUSCH) transmission from the first UE or the second UE based on the TAC.
